(19) United States
(12) Patent Application Publication
(10) Pub. No.: US 2025/0259265 A1
(43) Pub. Date: Aug. 14, 2025

(54) DATA PROCESSING APPARATUS, MAGNETIC RESONANCE IMAGING APPARATUS, AND DATA PROCESSING METHOD

(71) Applicant: CANON MEDICAL SYSTEMS CORPORATION, Tochigi (JP)

(72) Inventors: Hideaki KUTSUNA, Kawasaki (JP); Shun UEMATSU, Nasushiobara (JP); Kensuke SHINODA, Otawara (JP)

(73) Assignee: CANON MEDICAL SYSTEMS CORPORATION, Tochigi (JP)

(21) Appl. No.: 19/050,501

(22) Filed: Feb. 11, 2025

(30) Foreign Application Priority Data
Feb. 13, 2024 (JP) 2024-019587

(51) Int. Cl. G06T 3/4046; G06T 3/4053; G06T 11/00

(52) U.S. Cl. CPC G06T 3/4046; G06T 3/4053; G06T 11/006; G06T 2210/41; G06T 2211/441

(57) ABSTRACT

A data processing apparatus according to an embodiment includes processing circuitry. The processing circuitry is configured to output first complementary data by inputting, to a first neural network, first partial sampling data resulting from performing a partial sampling process; to obtain first corrected data, by performing a process to improve a consistency degree between the first complementary data and the first partial sampling data; to generate second partial sampling data, on the basis of the first corrected data and the first partial sampling data; and to output second complementary data, by inputting the second partial sampling data to a second neural network.

### CROSS-REFERENCE TO RELATED APPLICATIONS

This application is based upon and claims the benefit of priority from Japanese Patent Application No. 2024-019587, filed on Feb. 13, 2024; the entire contents of which are incorporated herein by reference.

### FIELD

Embodiments described herein relate generally to a data processing apparatus, a magnetic resonance imaging apparatus, and a data processing method.

### BACKGROUND

A method is known by which image reconstruction is carried out by combining machine learning with a Data Consistency (DC) process. According to this method, a full sampling magnetic resonance image is reconstructed from multi-channel data resulting from a partial sampling process, by carrying out an iterative process multiple times while each repetitive session includes a neural network and the DC process. In this situation, mutually the same value shared among the neural networks is used as a weight coefficient by a plurality of neural networks.

However, according to this method, it may not be possible to obtain a proper output result, in some situations. One possible solution to this problem may be to carry out training in an end-to-end manner while including the DC process, so that each of the neural networks independently determines a weight coefficient. However, this solution has low learning efficiency.

### BRIEF DESCRIPTION OF THE DRAWINGS

FIG. 1 is a diagram illustrating an exemplary configuration of a data processing apparatus according to an embodiment;

FIG. 2 is a diagram illustrating an exemplary configuration of a magnetic resonance imaging apparatus according to the embodiment;

FIG. 3 is a flowchart for explaining a flow of processes performed by a data processing apparatus according to a first embodiment;

FIG. 4 is a drawing for explaining processes performed by the data processing apparatus according to the first embodiment;

FIG. 5 is a drawing for explaining processes performed by the data processing apparatus according to the first embodiment, in an example of super-resolution processing;

FIG. 6 is a drawing for explaining processes performed by the data processing apparatus according to the first embodiment, in an example of compressed sensing;

FIG. 7 is a flowchart for explaining a flow of processes performed by the data processing apparatus according to the first embodiment;

FIG. 8 is a flowchart for explaining another flow of processes performed by the data processing apparatus according to the first embodiment;

FIG. 9 is a drawing for explaining processes performed by a data processing apparatus according to a second embodiment;

FIG. 10 is a drawing for explaining processes performed by a data processing apparatus according to a third embodiment;

FIG. 11 is another drawing for explaining processes performed by the data processing apparatus according to the third embodiment;

FIG. 12 is a drawing for explaining processes performed by a data processing apparatus according to a fourth embodiment; and

FIG. 13 is a drawing for explaining processes performed by a data processing apparatus according to a fifth embodiment.

### DETAILED DESCRIPTION

A data processing apparatus provided in at least one aspect of the present disclosure includes processing circuitry. The processing circuitry is configured to output first complementary data by inputting, to a first neural network, first partial sampling data resulting from performing a partial sampling process; to obtain first corrected data, by performing a process to improve a consistency degree between the first complementary data and the first partial sampling data; to generate second partial sampling data, on the basis of the first corrected data and the first partial sampling data; and to output second complementary data, by inputting the second partial sampling data to a second neural network.

### First Embodiment

Exemplary embodiments of a data processing apparatus, a magnetic resonance imaging apparatus, and a data processing method will be explained in detail below, with reference to the accompanying drawings.

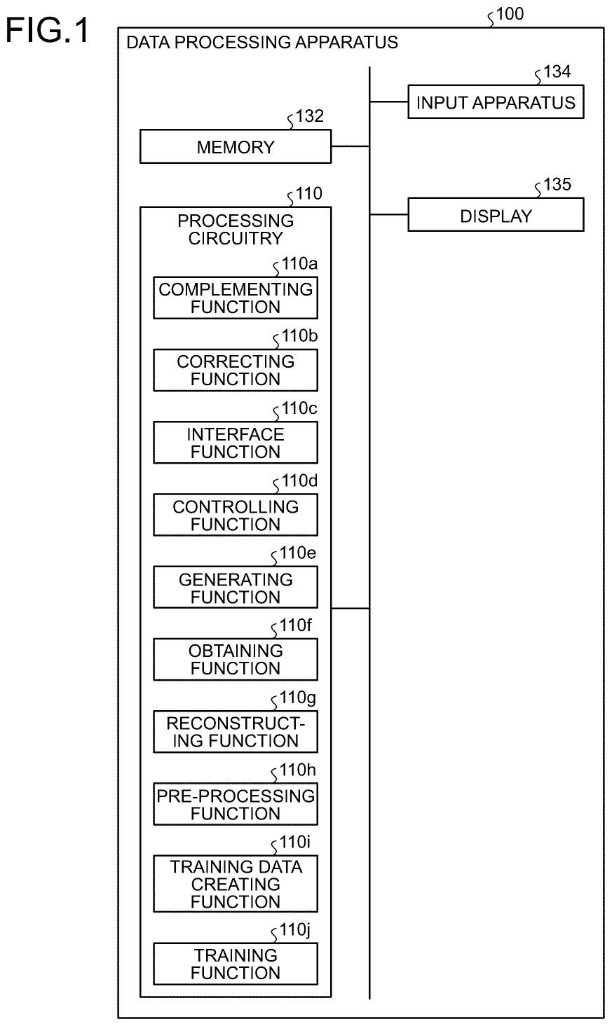

To begin with, a configuration of a data processing apparatus 100 according to an embodiment will be explained, with reference to FIG. 1.

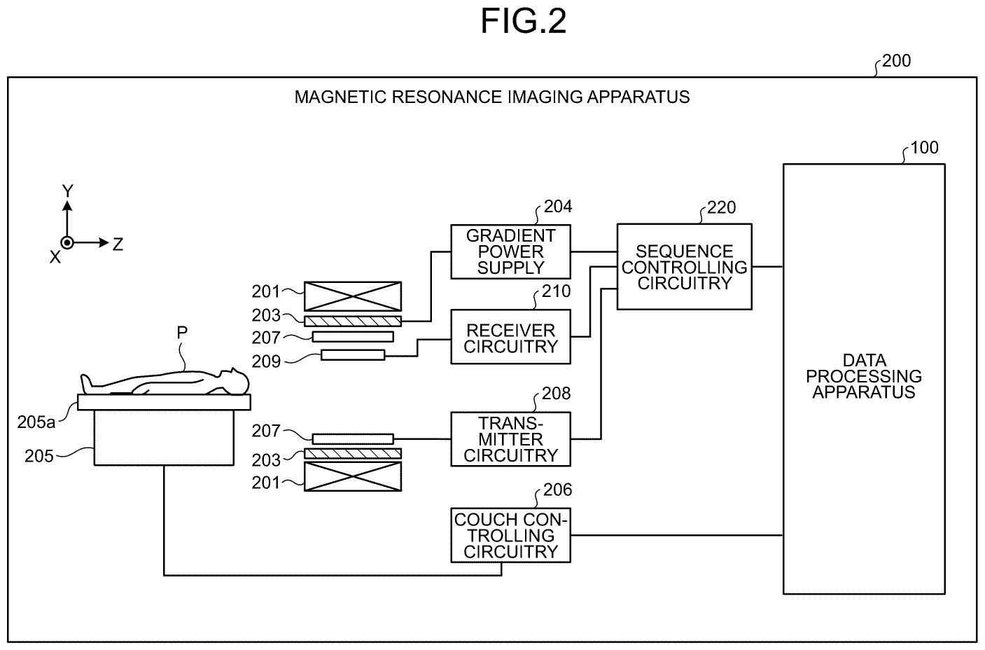

The data processing apparatus 100 is an apparatus configured to generate data and to carry out image reconstruction by using a neural network. In an example, the data processing apparatus 100 is connected to various medical image diagnosis apparatuses such as a magnetic resonance imaging apparatus 200 illustrated in FIG. 2, for instance, and is configured to process a signal received from any of the medical image diagnosis apparatuses, to generate/execute a trained model, and to carry out image reconstructing processes, and the like. In this situation, examples of the medical image diagnosis apparatuses to which the data processing apparatus 100 is connected may include apparatuses other than the magnetic resonance imaging apparatus, such as an ultrasound diagnosis apparatus, a general X-ray imaging apparatus, an X-ray Computed Tomography (CT) apparatus, a Positron Emission Tomography (PET) apparatus, and a Single Photon Emission Computed Tomography (SPECT) apparatus, for instance.

Typically, the data processing apparatus 100 is a medical data processing apparatus configured to process medical data. However, possible embodiments are not limited to the situation where the data processing apparatus 100 is a medical data processing apparatus. In another example, the data processing apparatus 100 may be an apparatus configured to process magnetic resonance data that is not medical data.

The data processing apparatus 100 includes processing circuitry 110, a memory 132, an input apparatus 134, and a display 135. The processing circuitry 110 includes a complementing function 110a, a correcting function 110b, an interface function 110c, a controlling function 110d, a generating function 110e, an obtaining function 110f, a reconstructing function 110g, a pre-processing function 110h, a training data creating function 110i, and a training function 110j.

In an embodiment, processing functions performed by the complementing function 110a, the correcting function 110b, the interface function 110c, the controlling function 110d, the generating function 110e, the obtaining function 110f, the reconstructing function 110g, the pre-processing function 110h, the training data creating function 110i, and the training function 110j, as well as the trained model (e.g., a neural network) are stored in the memory 132 in the form of computer-executable programs. The processing circuitry 110 is a processor configured to realize the functions corresponding to the programs, by reading and executing the programs from the memory 132. In other words, the processing circuitry 110 that has read the programs has the functions illustrated within the processing circuitry 110 in FIG. 1. Further, when having read the program corresponding to the trained model (a neural network), the processing circuitry 110 is capable of performing processes in accordance with the trained model. Further, although an example is explained with reference to FIG. 1 in which the functions of the processing circuitry 110 are realized by a single piece of processing circuitry, it is also acceptable to structure the processing circuitry 110 by combining together a plurality of independent processors, so that the functions are realized as a result of the processors executing the programs. In other words, each of the abovementioned functions may be structured as a program, so that a single piece of processing circuitry executes the programs. Further, a single piece of processing circuitry may realize two or more of the functions included in the processing circuitry 110. In another example, specific one or more of the functions may be installed in dedicated and independent program execution circuitry.

Further, in FIG. 1, the processing circuitry 110, the complementing function 110a, the correcting function 110b, the interface function 110c, the controlling function 110d, the generating function 110e, the obtaining function 110f, the reconstructing function 110g, the pre-processing function 110h, the training data creating function 110i, and the training function 110j are examples of a complementing unit, a correcting unit, an interface unit, a controlling unit, a generating unit, an obtaining unit, a reconstructing unit, a pre-processing unit, a creating unit, and a training unit, respectively.

The term “processor” used in the above explanations may denote, for example, a Central Processing Unit (CPU), a Graphical Processing Unit (GPU), or circuitry such as an Application Specific Integrated Circuit (ASIC) or a programmable logic device (e.g., a Simple Programmable Logic Device (SPLD), a Complex Programmable Logic Device (CPLD), or a Field Programmable Gate Array (FPGA)). The one or more processors are configured to realize the functions by reading and executing the programs saved in the memory 132.

Further, instead of having the programs saved in the memory 132, another configuration is also acceptable in which the programs are directly incorporated in the circuitry of one or more processors. In that situation, the one or more processors are configured to realize the functions by reading and executing the programs incorporated in the circuitry thereof. Accordingly, for example, instead of having the trained model saved in the memory 132, it is also acceptable to directly incorporate a program related to the trained model into the circuitry of the one or more processors.

Further, when being incorporated in various types of medical image diagnosis apparatuses or being configured to perform processes in collaboration with various types of medical image diagnosis apparatuses, the processing circuitry 110 may have a function of executing processes relevant thereto in a combined manner.

By employing the interface function 110c, the processing circuitry 110 is configured to obtain, from the memory 132, data, image, and/or the like used for an image generating process realized by the reconstructing function 110g.

By employing the controlling function 110d, the processing circuitry 110 is configured to control overall processes performed by the data processing apparatus 100. More specifically, by employing the controlling function 110d, the processing circuitry 110 is configured to control processes performed by the processing circuitry 110, on the basis of various types of setting requests input by an operator via the input apparatus 134 or any of various types of control programs and various types of data read from the memory 132.

By employing the training data creating function 110i, the processing circuitry 110 is configured to generate training data for carrying out training, on the basis of the data and/or the image obtained by the interface function 110c. By employing the training function 110j, the processing circuitry 110 is configured to generate the trained model by carrying out the training with the use of the training data generated by the training data creating function 110i. Further, by employing the reconstructing function 110g, the processing circuitry 110 is configured to generate an image on the basis of a result of processes performed by employing the training data creating function 110i and the training function 110j.

Further, by employing the reconstructing function 110g, the processing circuitry 110 is configured to apply the trained model generated by the training function 110j to an input image and is configured to generate an image on the basis of a result of applying the trained model.

Further, details of the complementing function 110a, the correcting function 110b, the generating function 110e, the obtaining function 110f, and the pre-processing function 110h will be explained later.

The memory 132 is configured by using a semiconductor memory element such as a Random Access memory (RAM) or a flash memory, or a hard disk, an optical disc, or the like. The memory 132 is a memory configured to store data therein, such as display-purpose image data and training-purpose image data generated by the processing circuitry 110.

The memory 132 is configured to store therein, as necessary, various types of data such as a control program for performing an image processing process and a display process.

The input apparatus 134 is configured to receive various types of instructions and inputs of information from the operator. For example, the input apparatus 134 may be a pointing mechanism such as a mouse or a trackball, a selecting mechanism such as a mode changing switch, and/or an input mechanism such as a keyboard.

The display 135 is configured, under control of the controlling function 110d or the like, to display a Graphical User Interface (GUI) for receiving an input of an image taking condition and an image generated by the controlling function 110d or the like. For example, the display 135 may be a display mechanism such as a liquid crystal display monitor. The display 135 is an example of a display unit. The display 135 has a mouse, a keyboard, a button, a panel switch, a touch command screen, a foot switch, a trackball, a joystick, and/or the like.

FIG. 2 illustrates an example of the magnetic resonance imaging apparatus 200 in which the data processing apparatus 100 according to the embodiment is incorporated.

As illustrated in FIG. 2, the magnetic resonance imaging apparatus 200 includes a static magnetic field magnet 201, a static magnetic field power source (not illustrated), a gradient coil 203, a gradient power supply 204, a couch 205, couch controlling circuitry 206, a transmitter coil 207, transmitter circuitry 208, a receiver coil 209, receiver circuitry 210, sequence controlling circuitry 220 (a sequence controlling unit), and the data processing apparatus 100 explained with reference to FIG. 1. In this situation, an examined subject (hereinafter, “patient”) P (e.g., a human body) is not included in the magnetic resonance imaging apparatus 200. Further, the configuration illustrated in FIG. 2 is merely an example.

The static magnetic field magnet 201 is a magnet formed to have a hollow and substantially circular cylindrical shape and is configured to generate a static magnetic field in a space on the inside thereof. For example, the static magnetic field magnet 201 may be a superconductive magnet or the like and is configured to be excited magnetically by receiving a supply of an electric current from the static magnetic field power source. The static magnetic field power source is configured to supply the electric current to the static magnetic field magnet 201. In another example, the static magnetic field magnet 201 may be a permanent magnet. In that situation, the magnetic resonance imaging apparatus 200 does not necessarily need to include the static magnetic field power supply. Alternatively, the static magnetic field power supply may be provided separately from the magnetic resonance imaging apparatus 200.

The gradient coil 203 is a coil formed to have a hollow and substantially circular cylindrical shape and is provided on the inside of the static magnetic field magnet 201. The gradient coil 203 is formed by combining together three coils corresponding to an X-axis, a Y-axis, and a Z-axis that are orthogonal to one another. The three coils are configured to generate gradient magnetic fields of which magnetic field intensities change along the X-, Y-, and Z-axes by individually receiving a supply of an electric current from the gradient power supply 204. The gradient magnetic fields generated along the X-, Y-, and Z-axes by the gradient coil 203 may be referred to, for example, as a slice gradient magnetic field Gs, a phase encoding gradient magnetic field Ge, and a read-out gradient magnetic field Gr. The gradient power supply 204 is configured to supply the electric currents to the gradient coil 203.

The couch 205 includes a couchtop 205a on which the patient P is placed. Under control of the couch controlling circuitry 206, the couchtop 205a is inserted into the hollow space (an image taking opening) of the gradient coil 203, while the patient P is placed thereon. Normally, the couch 205 is installed in such a manner that the longitudinal direction thereof extends parallel to the central axis of the static magnetic field magnet 201. Under control of the data processing apparatus 100, the couch controlling circuitry 206 is configured to move the couchtop 205a in longitudinal directions and up-and-down directions by driving the couch 205.

The transmitter coil 207 is provided on the inside of the gradient magnetic coil 203 and is configured to generate a radio frequency magnetic field by receiving a supply of a Radio Frequency (RF) pulse from the transmitter circuitry 208. The transmitter circuitry 208 is configured to supply the RF pulse corresponding to a Larmor frequency defined by the type of targeted atoms and the magnetic field intensities, to the transmitter coil 207.

The receiver coil 209 is provided on the inside of the gradient coil 203 and is configured to receive a magnetic resonance signal (hereinafter, “MR signal”, as necessary) emitted from the patient P due to an influence of the radio frequency magnetic field. Upon receipt of the magnetic resonance signal, the receiver coil 209 is configured to output the received magnetic resonance signal to the receiver circuitry 210.

In this situation, the transmitter coil 207 and the receiver coil 209 described above are merely examples. The configuration may use a selected one, or two or more in combination, from among the following: a coil provided only with a transmitting function; a coil provided only with a receiving function; and a coil provided with a transmitting/receiving function.

The receiver circuitry 210 is configured to detect the magnetic resonance signal output from the receiver coil 209 and to generate magnetic resonance data on the basis of the detected magnetic resonance signal. More specifically, the receiver circuitry 210 is configured to generate the magnetic resonance data by performing a digital conversion on the magnetic resonance signal output from the receiver coil 209. Further, the receiver circuitry 210 is configured to transmit the generated magnetic resonance data to the sequence controlling circuitry 220. In an example, the receiver circuitry 210 may be provided as a part of a gantry apparatus in which the static magnetic field magnet 201, the gradient coil 203, and the like are provided.

The sequence controlling circuitry 220 is configured to perform an imaging process on the patient P, by driving the gradient power supply 204, the transmitter circuitry 208, and the receiver circuitry 210, on the basis of sequence information. In this situation, the sequence information is information defining a procedure for performing the imaging process. The sequence information defines: an intensity of the electric current and timing with which the electric current is to be supplied by the gradient power supply 204 to the gradient coil 203 and the intensity of the electric current to be supplied; an intensity of the RF pulse and timing with which the RF pulse is to be supplied by the transmitter circuitry 208 to the transmitter coil 207; and timing with which the magnetic resonance signal is detected by the receiver circuitry 210; and the like. For example, the sequence controlling circuitry 220 may be integrated circuitry such as an Application Specific Integrated Circuit (ASIC) or a Field Programmable Gate Array (FPGA) or may be electronic circuitry such as a Central Processing Unit (CPU) or a Micro Processing Unit (MPU). The sequence controlling circuitry 220 is an example of a scan unit.

Further, when having received the magnetic resonance data from the receiver circuitry 210, as a result of imaging the patient P by driving the gradient power supply 204, the transmitter circuitry 208, and the receiver circuitry 210, the sequence controlling circuitry 220 is configured to transfer the received magnetic resonance data to the data processing apparatus 100. In addition to the processes explained with reference to FIG. 1, the data processing apparatus 100 is configured to control the entirety of the magnetic resonance imaging apparatus 200.

With reference back to FIG. 1, processes performed by the data processing apparatus 100 that are other than those explained with reference to FIG. 1 will be explained. By employing the interface function 110c, the processing circuitry 110 is configured to transmit the sequence information to the sequence controlling circuitry 220 and configured to receive the magnetic resonance data from the sequence controlling circuitry 220. Also, upon receipt of the magnetic resonance data, the processing circuitry 110 including the interface function 110c is configured to store the received magnetic resonance data into the memory 132.

The magnetic resonance data stored in the memory 132 is arranged in a k-space by the controlling function 110d. As a result, the memory 132 has k-space data stored therein.

The memory 132 is configured to store therein the magnetic resonance data received by the processing circuitry 110 including the interface function 110c, the k-space data arranged in the k-space by the processing circuitry 110 including the controlling function 110d, image data generated by the processing circuitry 110 including the reconstructing function 110g, and the like.

By employing the controlling function 110d, the processing circuitry 110 is configured to control imaging processes, image generating processes, image displaying processes, and the like, by controlling the entirety of the magnetic resonance imaging apparatus 200. For example, the processing circuitry 110 including the controlling function 110d is configured to receive, via the GUI, the input of the image taking condition (e.g., an imaging parameter) and to generate the sequence information according to the received image taking condition. Further, the processing circuitry 110 including the controlling function 110d is configured to transmit the generated sequence information to the sequence controlling circuitry 220.

By employing the reconstructing function 110g, the processing circuitry 110 is configured to generate a magnetic resonance image by reading the k-space data from the memory 132 and performing a reconstructing process such as a Fourier transform on the read k-space data.

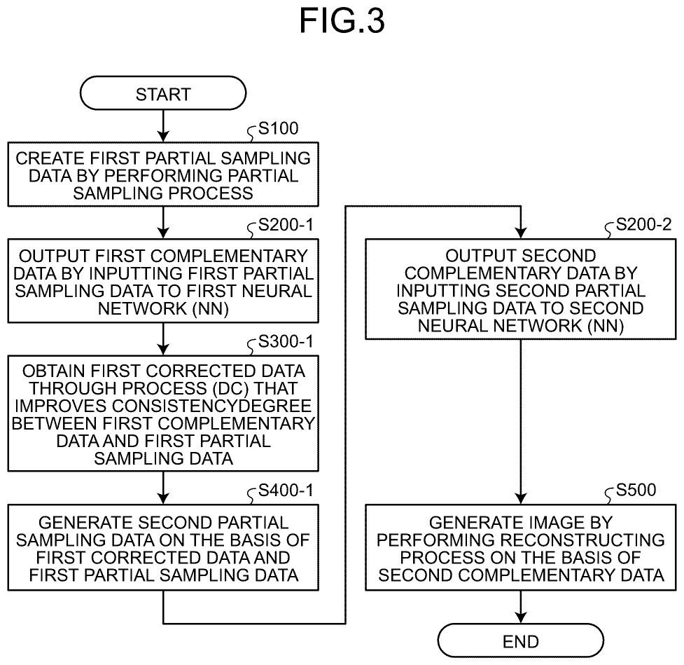

Next, processes performed by the data processing apparatus 100 according to an embodiment will be explained. FIG. 3 is a flowchart for explaining a flow of the processes performed by the data processing apparatus 100 according to the embodiment.

To begin with, at step S100, for example, a medical image diagnosis apparatus connected to the data processing apparatus 100 creates first partial sampling data by performing an imaging/imaging taking process while carrying out a partial sampling process by which an acquisition is performed with a data volume smaller than that in a full sampling process. In an example, when the medical image diagnosis apparatus connected to the data processing apparatus 100 is the magnetic resonance imaging apparatus 200, the sequence controlling circuitry 220 included in the magnetic resonance imaging apparatus 200 generates the first partial sampling data being magnetic resonance imaging data, by carrying out a magnetic resonance imaging process by executing a pulse sequence, while performing the partial sampling process by which the acquisition is performed with a data volume smaller than that in a full sampling process. As compared to k-space data from a full sampling process, the first partial sampling data may be, for example, k-space data obtained by thinning out the k-space data. By employing the obtaining function 110f, the processing circuitry 110 is configured to obtain the first partial sampling data.

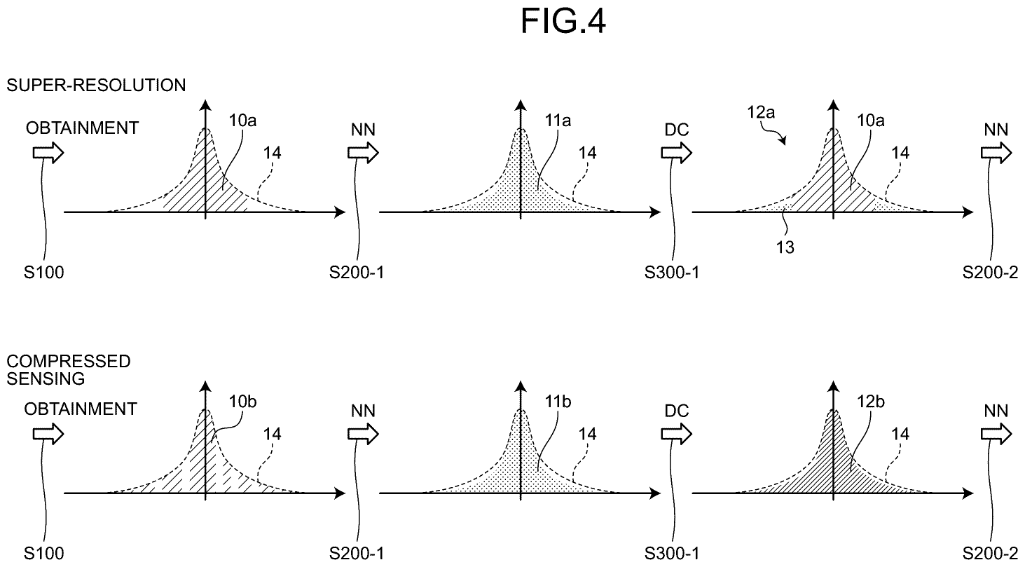

In an example where super-resolution processing is to be carried out, which is processing involving a process to estimate full k-space data from k-space data of only the vicinity of the center of the k-space, for example, the processing circuitry 110 is configured to obtain first partial sampling data 10a by employing the obtaining function 110f, as illustrated in the top section of FIG. 4. The first partial sampling data 10a is data resulting from performing a partial sampling process (a subsampling process) and missing a part of the k-space data, as compared to k-space data 14 resulting from a full sampling process. In the example of the super-resolution processing, the first partial sampling data 10a is data obtained by extracting the data in the vicinity of the center of the k-space, as compared to full-size k-space data. Each of the graphs in FIG. 4 indicates, in a schematic chart, an outline of the k-space data, while the horizontal axis expresses positions in the k-space, whereas the vertical axis expresses signal values. The graphs in FIG. 4 are merely schematic charts. Generally speaking, the first partial sampling data 10a in actuality is not one-dimensional k-space data, but is multi-dimensional k-space data.

Further, the bottom section of FIG. 4 illustrates an example in which compressed sensing is carried out. When the compressed sensing is to be carried out, as indicated in the bottom section of FIG. 4, the processing circuitry 110 is configured to obtain first partial sampling data 10b by employing the obtaining function 110f. The first partial sampling data 10b is data resulting from a partial sampling process (a subsampling process) and missing a part of the k-space data, as compared to the k-space data 14 resulting from the full sampling process. In the example of the compressed sensing, the first partial sampling data 10b is data obtained by thinning out the full-size k-space data 14. Unlike the first partial sampling data 10a being data of regions coupled by a k-space, the first partial sampling data 10b in the example of the compressed sensing is non-coupled k-space data.

After that, at step S200-1, by employing the complementing function 110a, the processing circuitry 110 outputs first complementary data by inputting the first partial sampling data resulting from the partial sampling process, to a first neural network. In other words, the first neural network is configured to receive the input of the data missing a part of the k-space and to estimate and output full-size k-space data. In the example of the super-resolution processing, as illustrated in the top section of FIG. 4, by employing the complementing function 110a, the processing circuitry 110 outputs first complementary data 11a by inputting the first partial sampling data 10a to the first neural network. The first complementary data 11a is data spreading over the entire k-space, as compared to the first partial sampling data 10a. In contrast, in the example of the compressed sensing, by employing the complementing function 110a, the processing circuitry 110 outputs first complementary data 11b by inputting the first partial sampling data 10b to the first neural network. The first complementary data 11b is data spreading over the entire k-space, as compared to the first partial sampling data 10b being the data thinned out within the k-space.

Subsequently, at step S300-1, by employing the correcting function 110b, the processing circuitry 110 obtains first corrected data by performing a Data Consistency (DC) process, which is a process to improve a consistency degree between the first complementary data and the first partial sampling data.

In the example of the super-resolution processing, as a result of performing the DC process, which is a process to improve a consistency degree between the first complementary data 11a and the first partial sampling data 10a, the processing circuitry 110 obtains first corrected data 12a by employing the correcting function 110b. For example, the first corrected data 12a is data being the first partial sampling data 10a within the k-space in which the first partial sampling data is present but, in other k-spaces, is data being data 13, which is the same data as the first complementary data 11a.

In contrast, in the example of the compressed sensing, as a result of performing the DC process, which is a process to improve a consistency degree between the first complementary data 11b and the first partial sampling data 10b, the processing circuitry 110 obtains first corrected data 12b by employing the correcting function 110b. Subsequently, at step S400-1, by employing the generating function 110e, the processing circuitry 110 generates second partial sampling data obtained by updating the first partial sampling data, on the basis of the first corrected data and the first partial sampling data.

Next, a background of performing the process at step S400-1 in the embodiment will briefly be explained.

When image reconstruction is carried out by complementing k-space data through machine learning, for example, it is possible to reconstruct an image corresponding to full sampling of a k-space, on the basis of partial sampling data of the k-space, by calculating, through a learning process, a weight coefficient for a neural network configured, for example, to receive an input of partial sampling data of a k-space and to output a reconstructed image. Examples of this type of method include a method using super-resolution processing as a base and a method using compressed sensing as a base. According to the method using super-resolution processing as a base, the data in the vicinity of the center of the k-space serves as the partial sampling data to be input to the neural network. In contrast, according to the method using compressed sensing as a base, k-space data obtained by thinning out data in the k-space serves as the partial sampling data to be input to the neural network.

Further, another method is also known by which image reconstruction is carried out by combining machine learning such as Model-based Deep Learning (MoDL) with a Data Consistency (DC) process. According to this method, by carrying out an iterative process multiple times while each repetitive session includes a neural network and the DC process, a full sampling image is reconstructed from multi-channel data resulting from a partial sampling process. In this situation, used as a weight coefficient by a plurality of networks is mutually the same value shared among the neural networks.

In this situation, when the process at step S400-1 is skipped so as to proceed to the process at step S200-2 and to input the first corrected data 12a to a second neural network, characteristics of the first corrected data 12a input to the second neural network are different from characteristics of the first partial sampling data 10a input to the first neural network. For example, the first corrected data 12a includes the k-space data 13 which is not included in the first partial sampling data 10a. For this reason, for example, if the value of the weight coefficient learned in the first neural network is re-used as the value of the weight coefficient for the second neural network, there is a possibility that a proper output result may not be obtained.

One possible solution to this problem may be, instead of having the weight coefficient learned by the one neural network and re-using the weight coefficient in another neural network, to carry out training in an end-to-end manner while including the DC process, so that each of the neural networks independently determines a weight coefficient. However, this solution has low learning efficiency.

To cope with the situation, in the embodiment, by employing the generating function 110e, the processing circuitry 110 is configured to determine a correction amount for the first partial sampling data 10a being input data, on the basis of the first complementary data 11a being pre-DC process data and the first corrected data 12a being post-DC process data and configured to use the first partial sampling data 10a that has been corrected as second partial sampling data to be input to the next neural network. On such occasion, a correcting process is performed so that the second partial sampling data, which is the first partial sampling data 10a that has been corrected, becomes partial sampling data having the same characteristics as those of the first partial sampling data 10a. As a result, it is possible to re-use a weight coefficient learned in one neural network in another neural network and to thus eliminate the need to carry out the end-to-end training process including the DC process. With this configuration, the learning efficiency is expected to be enhanced.

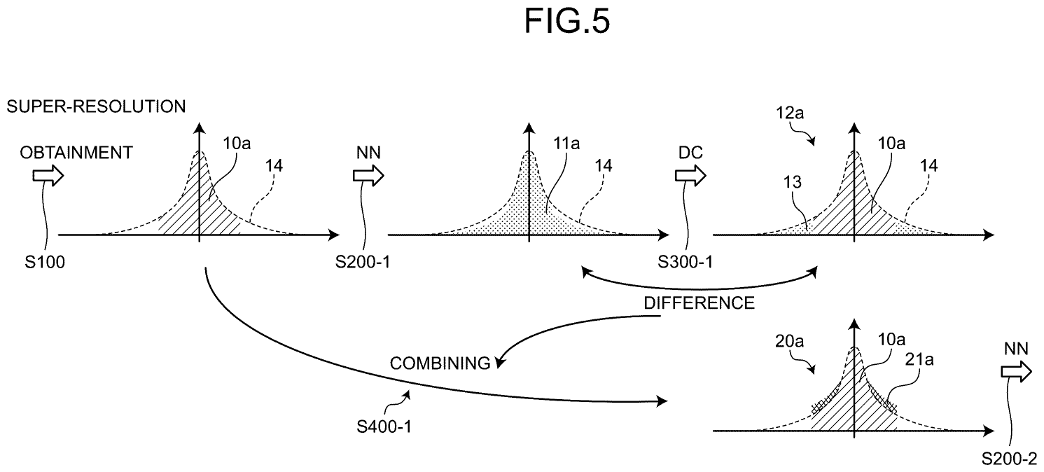

FIG. 5 illustrates a process at step S400-1 in the example of the super-resolution processing. Because the processes at steps S100, S200-1, and S300-1 are the same as those in FIG. 4, duplicate explanations thereof will be omitted. At step S400-1, by employing the generating function 110e, the processing circuitry 110 generates second partial sampling data 20a obtained by updating the first partial sampling data 10a, on the basis of the first corrected data 12a and the first partial sampling data 10a. In an example, by employing the generating function 110e, the processing circuitry 110 generates the second partial sampling data 20a, on the basis of a difference between the first corrected data 12a and the first complementary data 11a. More specifically, by employing the generating function 110e, the processing circuitry 110 calculates the difference between the first corrected data 12a and the first complementary data 11a. Subsequently, the processing circuitry 110 generates the second partial sampling data 20a, by adding an output of a mathematical function that uses the difference as an input, to the first partial sampling data 10a. In an example, the processing circuitry 110 generates the second partial sampling data 20a, by adding the difference to the first partial sampling data 10a. The second partial sampling data 20a is a result of adding data 21a to the first partial sampling data 10a. The second partial sampling data 20a is data obtained by sampling data points in the same positions as those used for the first partial sampling data 10a. As a result, this configuration makes it possible to re-use a weight coefficient from the first neural network also in the second neural network, and the learning efficiency is thus enhanced.

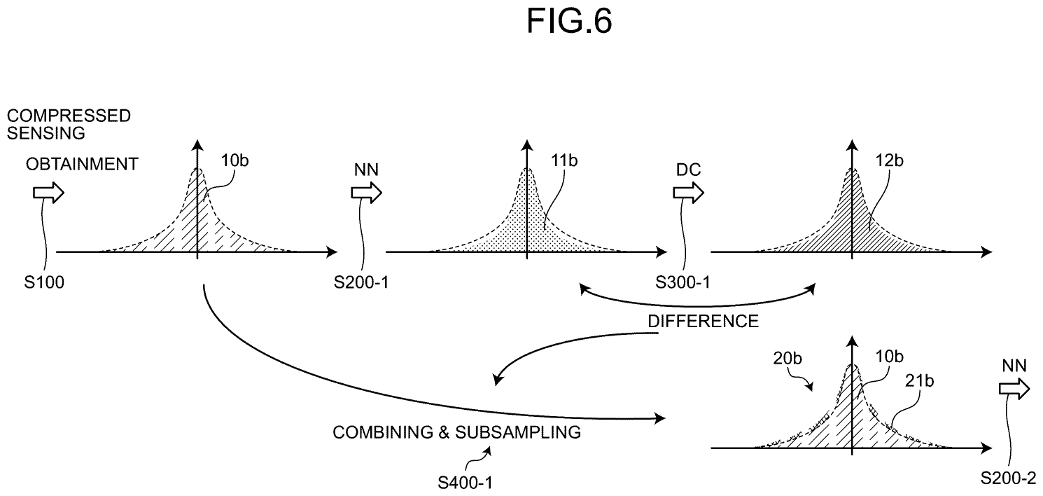

FIG. 6 illustrates a process at step S400-1 in the example of the compressed sensing. Because the processes at steps S100, S200-1, and S300-1 are the same as those in FIG. 4, duplicate explanations thereof will be omitted. At step S400-1, by employing the generating function 110e, the processing circuitry 110 generates second partial sampling data 20b obtained by updating the first partial sampling data 10b, on the basis of the first corrected data 12b and the first partial sampling data 10b. In an example, by employing the generating function 110e, the processing circuitry 110 generates the second partial sampling data 20b, on the basis of a difference between the first corrected data 12b and the first complementary data 11b. More specifically, by employing the generating function 110e, the processing circuitry 110 calculates the difference between the first corrected data 12b and the first complementary data 11b. Subsequently, by employing the generating function 110e, the processing circuitry 110 generates the second partial sampling data 20b, by adding an output of a mathematical function that uses the difference as an input, to the first partial sampling data 10b, and further including a process of carrying out a partial sampling process. In other words, by employing the generating function 110e, the processing circuitry 110 generates the second partial sampling data 20b, by adding the output of the mathematical function that uses the difference as an input, to the first partial sampling data 10b, and further performing the process of carrying out the partial sampling process thereon, for example, in the same positions as those used for the first partial sampling process. The second partial sampling data 20b is a result of adding data 21b to the first partial sampling data 10b. The second partial sampling data 20b is data obtained by sampling data points in the same positions as those used for the first partial sampling data 10b. As a result, this configuration makes it possible to re-use a weight coefficient from the first neural network also in the second neural network, and the learning efficiency is thus enhanced.

Returning to the description of FIG. 3, after that, at step S200-2, the processing circuitry 110 controls the complementing function 110a, the correcting function 110b, and the generating function 110e, by employing the controlling function 110d. Under control of the controlling function 110d, by employing the complementing function 110a, the processing circuitry 110 outputs second complementary data by inputting the second partial sampling data to the second neural network.

For instance, in the example of the super-resolution processing, by employing the controlling function 110d, the processing circuitry 110 controls the complementing function 110a, the correcting function 110b, and the generating function 110e. As illustrated in FIG. 5, under the control of the controlling function 110d, by employing the complementing function 110a, the processing circuitry 110 outputs second complementary data by inputting the second partial sampling data 20a to the second neural network.

In contrast, in the example of the compressed sensing, by employing the controlling function 110d, the processing circuitry 110 controls the complementing function 110a, the correcting function 110b, and the generating function 110e. As illustrated in FIG. 6, under the control of the controlling function 110d, by employing the complementing function 110a, the processing circuitry 110 outputs second complementary data, by inputting the second partial sampling data 20b to the second neural network.

Subsequently, at step S500, by employing the reconstructing function 110g, the processing circuitry 110 generates an image by performing a reconstructing process on the basis of the second complementary data.

Although the example was explained above in which the processing circuitry 110 is configured to generate the image by performing the reconstructing process on the basis of the second complementary data, possible embodiments are not limited to the above example. In another example, after step S200-2, under the control of the controlling function 110d, by employing the correcting function 110b, the processing circuitry 110 may obtain new first corrected data by using the second complementary data as new first complementary data and using the second partial sampling data as new first partial sampling data. By employing the reconstructing function 110g, the processing circuitry 110 may generate an image by performing a reconstructing process on the basis of the new first corrected data.

Further, although the example was explained above in which the processing circuitry 110 generates the image by performing the reconstructing process with the data correction, by employing the two neural networks, namely, the first neural network and the second neural network; however, possible embodiments are not limited to this example. The processing circuitry 110 may generate an image by performing a reconstructing process with a data correction that employs neural networks of which the quantity is expressed as n.

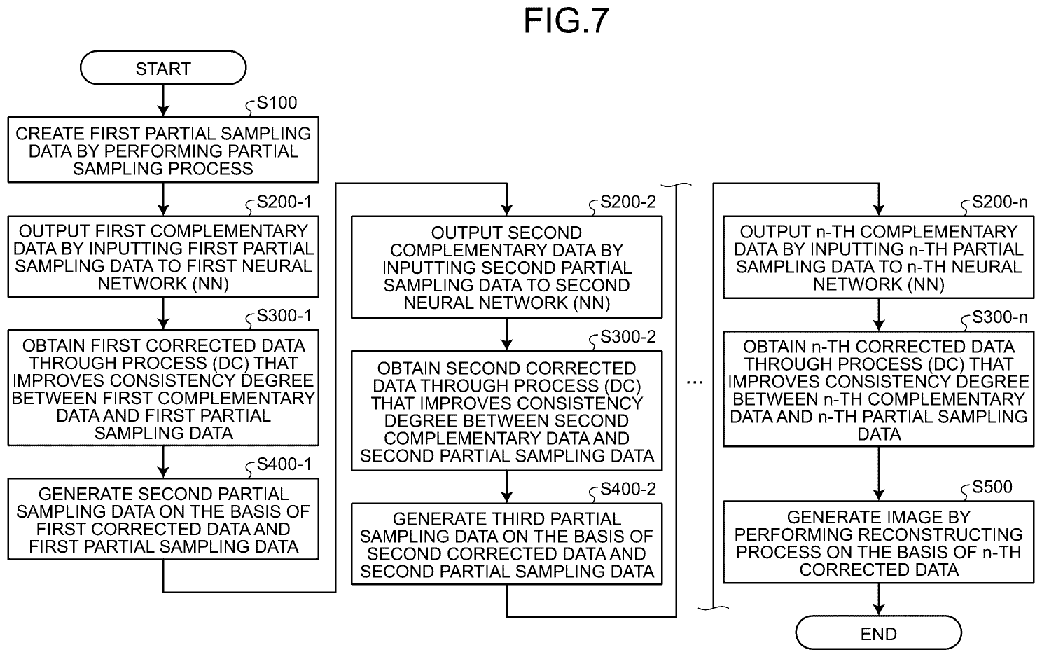

FIG. 7 illustrates an example with the above configuration. At step S200-m where m is a natural number, by employing the complementing function 110a, the processing circuitry 110 outputs m-th complementary data, by inputting m-th partial sampling data resulting from a partial sampling process to an m-th neural network. At step S300-m, by employing the correcting function 110b, the processing circuitry 110 obtains m-th corrected data, by performing the Data Consistency (DC) process, which is a process to improve a consistency degree between the m-th complementary data and the m-th partial sampling data. At step S400-m, by employing the generating function 110e, the processing circuitry 110 generates (m+1)-th partial sampling data obtained by updating the m-th partial sampling data on the basis of the m-th corrected data and the m-th partial sampling data. The processing circuitry 110 repeatedly performs the processes at steps S200-m and S300-m from “m=1” to “m=n−1” and the process at step S400-m from “m=1” to “m=n”. At step S500, by employing the reconstructing function 110g, the processing circuitry 110 generates an image by performing a reconstructing process on the basis of n-th corrected data.

Further, in FIG. 3, the second neural network may be the same neural network as the first neural network. Also, in FIG. 7, the second to the n-th neural networks may be the same as the first neural network. By allowing the second to the n-th neural networks to be the same as the first neural network, it is possible to re-use a weight coefficient from the first neural network in the other neural networks, and the learning efficiency is thus enhanced.

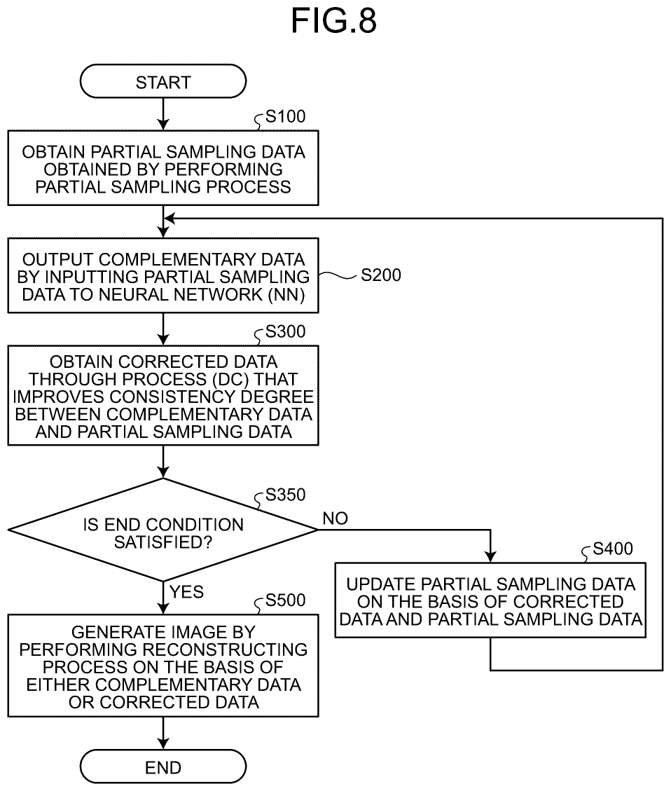

FIG. 8 illustrates a flowchart of processes to be performed when the second to the n-th neural networks are the same neural network as the first neural network.

At step S100, by employing the obtaining function 110f, the processing circuitry 110 obtains partial sampling data resulting from performing a partial sampling process. At step S200, by employing the complementing function 110a, the processing circuitry 110 outputs complementary data, by inputting the partial sampling data obtained at step S100 to a neural network. At step S300, by employing the correcting function 110b, the processing circuitry 110 obtains corrected data by performing the Data Consistency (DC) process, which is a process to improve a consistency degree between the complementary data and the partial sampling data. When an end condition is not satisfied (step S350: No), the process proceeds to step S400. At step S400, by employing the generating function 110e, the processing circuitry 110 updates the partial sampling data on the basis of the corrected data and the partial sampling data, and the process proceeds to step S200. On the contrary, when the end condition is satisfied (step S350: Yes), by employing the reconstructing function 110g, the processing circuitry 110 generates an image by performing a reconstructing process on the basis of either the complementary data or the corrected data.

As explained above, in the first embodiment, by employing the generating function 110e, the processing circuitry 110 is configured to generate the second partial sampling data obtained by updating the first partial sampling data, on the basis of the first corrected data and the first partial sampling data. As a result, this configuration makes it possible to re-use a weight coefficient from one neural network also in another neural network, and the learning efficiency is thus enhanced.

### Second Embodiment

In the first embodiment, the example among others was explained in which, in the process at step S300, the processing circuitry 110 is configured, by employing the generating function 110e, to calculate the difference between the first corrected data 12a and the first complementary data 11a and to further generate the second partial sampling data 20a, by adding the output of the mathematical function that uses the difference as an input, to the first partial sampling data 10a; however, possible embodiments are not limited to the example in which the second partial sampling data is generated on the basis of the difference between the corrected data and the complementary data. For instance, it is also acceptable to generate second partial sampling data, on the basis of a ratio between the corrected data and the complementary data.

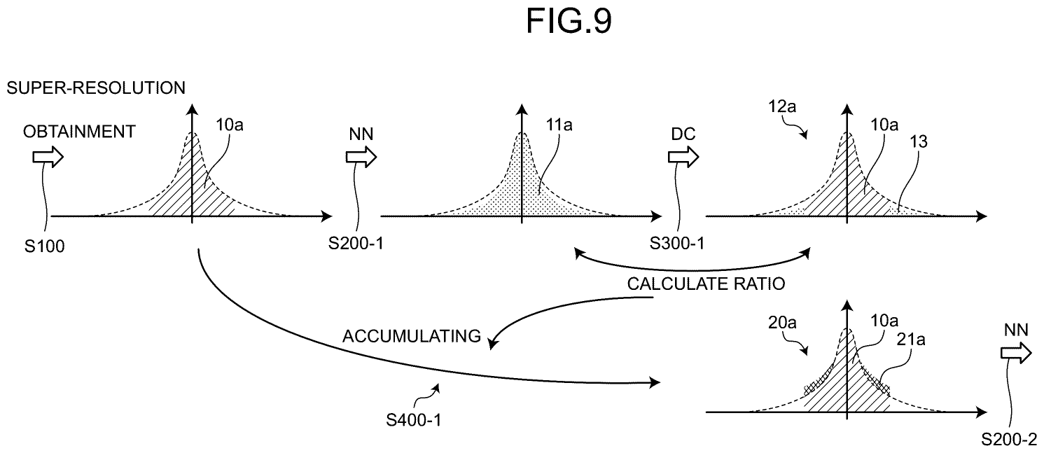

FIG. 9 illustrates an example with the above configuration. Because the processes at steps S100, S200-1, and S300-1 are the same as those in FIG. 5, duplicate explanations thereof will be omitted. At step S400-1, by employing the generating function 110e, the processing circuitry 110 generates the second partial sampling data 20a obtained by updating the first partial sampling data 10a, on the basis of the first corrected data 12a and the first partial sampling data 10a. In an example, by employing the generating function 110e, the processing circuitry 110 generates the second partial sampling data 20a, on the basis of a ratio between the first corrected data 12a and the first complementary data 11a. More specifically, by employing the generating function 110e, the processing circuitry 110 calculates the ratio between the first corrected data 12a and the first complementary data 11a. Subsequently, the processing circuitry 110 generates the second partial sampling data 20a, by multiplying the first partial sampling data 10a by an output of a mathematical function that uses the ratio as an input. In an example, the processing circuitry 110 generates the second partial sampling data 20a, by multiplying the first partial sampling data 10a by the ratio. The second partial sampling data 20a is a result of adding the data 21a to the first partial sampling data 10a. The second partial sampling data 20a is data obtained by sampling data points in the same positions as those used for the first partial sampling data 10a. As a result, this configuration makes it possible to re-use a weight coefficient from the first neural network also in the second neural network, and the learning efficiency is thus enhanced.

As explained above, in the second embodiment, by employing the generating function 110e, the processing circuitry 110 is configured to generate the second partial sampling data obtained by updating the first partial sampling data, on the basis of the ratio between the first corrected data 12a and the first complementary data 11a. Consequently, similarly to the first embodiment, it is possible to re-use a weight coefficient from one neural network also in another neural network, and the learning efficiency is thus enhanced.

### Third Embodiment

In a third embodiment, an example will be explained in which, at step S400-1, by employing the generating function 110e, the processing circuitry 110 is configured to generate second partial sampling data while including a process of carrying out a partial sampling process. In this situation, in the third embodiment, the partial sampling process at the time of generating the second partial sampling data is caused to be slightly different from that of the first partial sampling data. This configuration makes it possible to perform a more flexible process.

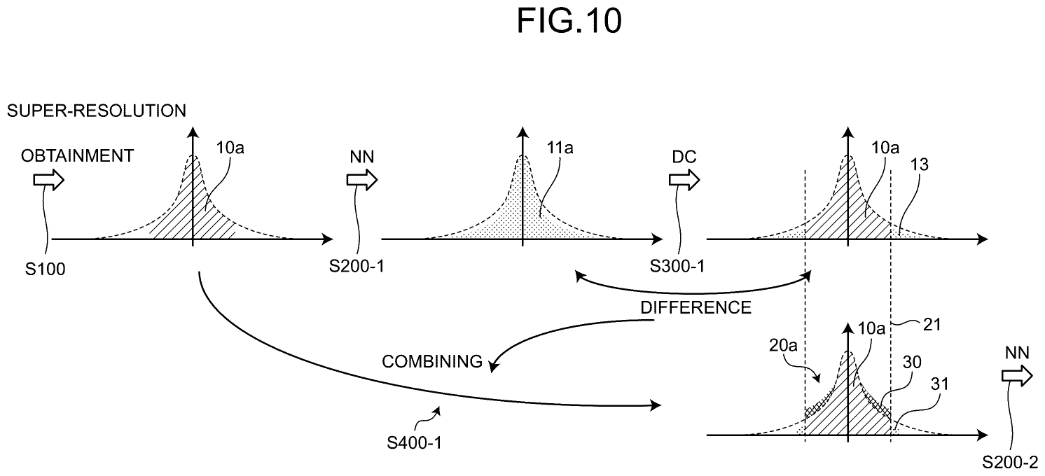

FIG. 10 illustrates a process at step S400-1 in the example of the super-resolution processing. Because the processes at steps S100, S200-1, and S300-1 are the same as those in FIG. 5, duplicate explanations thereof will be omitted. At step S400-1, by employing the generating function 110e, the processing circuitry 110 generates the second partial sampling data 20a obtained by updating the first partial sampling data 10a, on the basis of the first corrected data 12a and the first partial sampling data 10a. In an example, by employing the generating function 110e, the processing circuitry 110 generates the second partial sampling data 20a, on the basis of the difference between the first corrected data 12a and the first complementary data 11a. More specifically, by employing the generating function 110e, the processing circuitry 110 calculates the difference between the first corrected data 12a and the first complementary data 11a. Subsequently, the processing circuitry 110 generates the second partial sampling data 20a, by adding an output of a mathematical function that uses the difference as an input, to the first partial sampling data 10a, and further including a process of carrying out a partial sampling process. In this situation, the partial sampling process performed at the time of generating the second partial sampling data 20a uses a sampling percentage different from a sampling percentage used in the partial sampling process performed at the time of generating the first partial sampling data 10a. In an example, for the partial sampling process at the time of generating the second partial sampling data, the processing circuitry 110 performs the partial sampling process by making the sampling percentage slightly higher than that used at the time of generating the first partial sampling data, i.e., by making a thin-out percentage smaller. The second partial sampling data 20a obtained as a result includes, in addition to the first partial sampling data 10a and data 30, k-space data 31 in a small volume which was not included in the original first partial sampling data 10a. However, as a whole, the second partial sampling data 20a is data obtained by sampling data points in substantially the same positions as those used for the first partial sampling data 10a. As a result, this configuration makes it possible to substantially re-use a weight coefficient from the first network also in the second neural network.

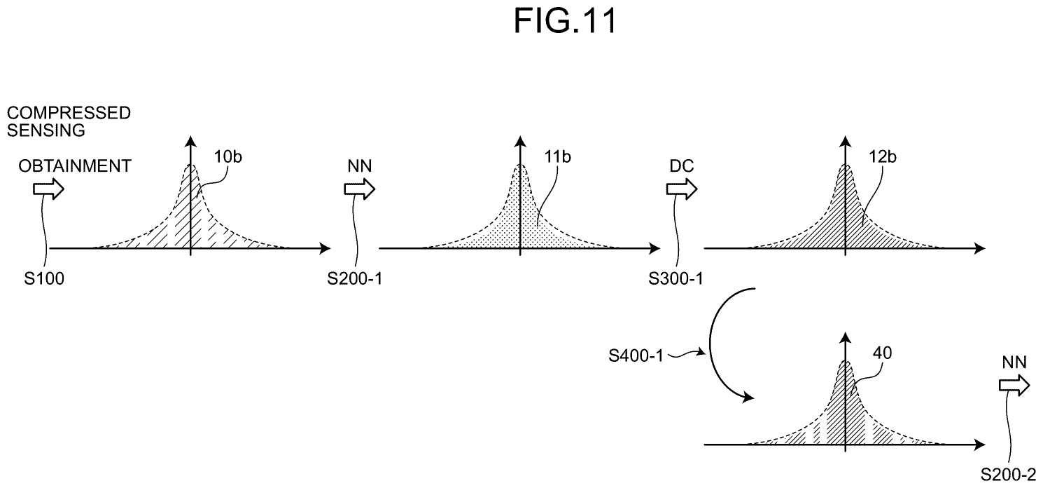

FIG. 11 illustrates another example of the process at step S400-1 in the example of the compressed sensing. Because the processes at steps S100, S200-1, and S300-1 are the same as those in FIG. 5, duplicate explanations thereof will be omitted. At step S400-1, by employing the generating function 110e, the processing circuitry 110 generates second partial sampling data 40 obtained by updating the first partial sampling data 10b, on the basis of the first corrected data 12b and the first partial sampling data 10b. In the example of the compressed sensing, difference data between the first corrected data 12b after the DC process and the first complementary data 11b before the DC process may not match the shape of the first partial sampling data 10b, in some situations. In those situations, by employing the generating function 110e, the processing circuitry 110 generates the second partial sampling data 40, by directly performing a partial sampling process on the first corrected data 12b. On such occasion, by employing the generating function 110e, the processing circuitry 110 carries out a process of generating the second partial sampling data 40, while ensuring that sampling positions in the partial sampling process performed at the time of generating second partial sampling data are different from sampling positions in the partial sampling process performed at the time of generating first partial sampling data. As a result, although the second partial sampling data 40 is data having the slightly different sampling positions from those of the first partial sampling data 10b, the difference is to such an extent that it is still possible to substantially re-use a weight coefficient from the first neural network also in the second neural network.

As explained above, in the third embodiment, by employing the generating function 110e, the processing circuitry 110 is configured to carry out the second partial sampling data, while including the process of carrying out the partial sampling process. Similarly to the first embodiment, in the third embodiment, it is possible to substantially re-use a weight coefficient from one neural network also in another neural network, and the learning efficiency is thus enhanced.

### Fourth Embodiment

In a fourth embodiment, an example among others will be explained in which the processing circuitry 110 includes a pre-processing unit configured to generate either first partial sampling data or second partial sampling data, by performing a pre-processing process on data resulting from a partial sampling process.

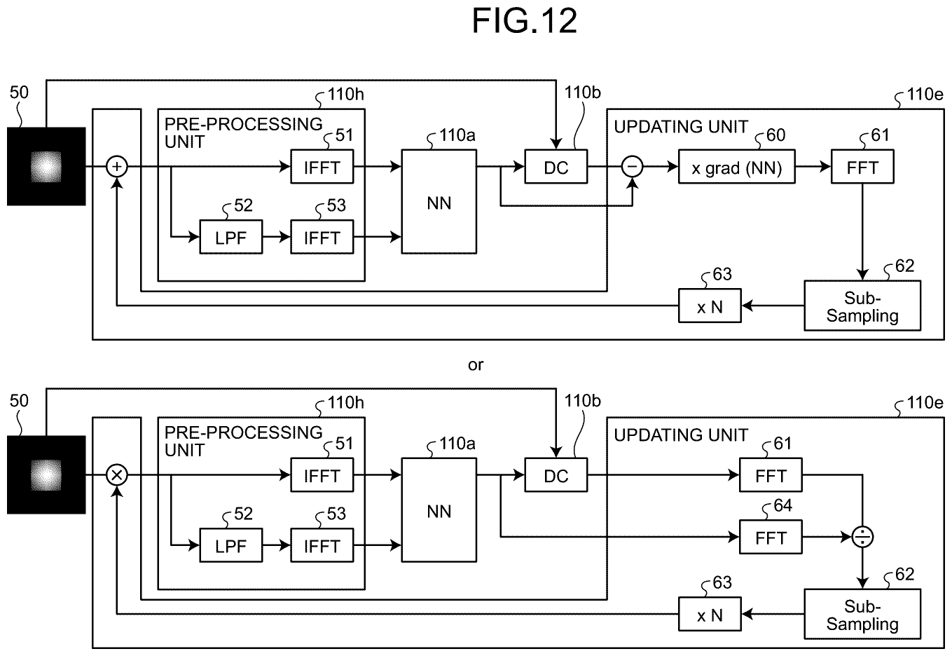

FIG. 12 illustrates an example with the above configuration. FIG. 12 illustrates an example of a super-resolution method using deep learning. According to this method, by employing the generating function 110e, a truncation artifact elimination process is repeatedly performed. Because the examples in both the top and the bottom sections of FIG. 12 can be regarded as corresponding to the example in the flowchart of FIG. 8, the following explanation will refer to the flowchart in FIG. 8.

At step S100, by employing the obtaining function 110f, the processing circuitry 110 obtains partial sampling data 50 resulting from performing a partial sampling process. At step S150, which is not illustrated in FIG. 8, by employing a pre-processing function 110h, the processing circuitry 110 generates data to be input to a neural work serving as the complementing function 110a, on the basis of the partial sampling data 50.

More specifically, by employing the pre-processing function 110h, the processing circuitry 110 carries out an Inverse Fast Fourier Transform (IFFT) 51 on the partial sampling data 50 and inputs the data to the neural work serving as the complementing function 110a. Also, by employing the pre-processing function 110h, the processing circuitry 110 applies a Low-Pass Filter (LPF) 52 to the partial sampling data 50, subsequently carries out an inverse fast Fourier transform 53 thereon, and inputs the data to the neural network serving as the complementing function 110a.

At step S200, by employing the complementing function 110a, the processing circuitry 110 outputs complementary data by inputting the data generated at step S150 to the neural network.

At step S300, by employing the correcting function 110b, the processing circuitry 110 obtains and outputs corrected data by performing a DC process, which is a process to improve a consistency degree between the complementary data and the partial sampling data 50.

When the end condition is not satisfied (step S350: No), the process proceeds to step S400. At step S400, by employing the generating function 110e, the processing circuitry 110 updates the partial sampling data on the basis of the corrected data and the partial sampling data 50, and the process proceeds to step S200.

More specifically, by employing the generating function 110e, the processing circuitry 110 calculates the difference between the complementary data output at step S200 and the corrected data output at step S300. After that, by employing the generating function 110e, the processing circuitry 110 subsequently generates second partial sampling data by using a gradient 60 of the first neural network.

More specifically, by employing the generating function 110e, the processing circuitry 110 calculates the gradient 60 of the first neural network through an error backpropagation or the like and further multiplies the calculated difference between the complementary data and the corrected data by the calculated gradient 60. After that, by employing the generating function 110e, the processing circuitry 110 carries out a Fast Fourier Transform (FFT) 61, subsequently performs a partial sampling process 62 thereon, carries out multiplication 63 by a scalar value N, and adds the result to the partial sampling data 50, so as to use the generated value as second partial sampling data serving as new partial sampling data.

On the contrary, when the end condition is satisfied (step S350: Yes), by employing the reconstructing function 110g, the processing circuitry 110 generates an image by performing a reconstructing process on the basis of either the complementary data or the corrected data.

In this situation, possible embodiments are not limited to the above example, and the processing circuitry 110 may perform the processes illustrated in the bottom section of FIG. 12. In the example in the bottom section of FIG. 12, the processes performed by the pre-processing unit are the same as those in the example in the top section of FIG. 12, but the processes performed by the generating unit are different. More specifically, in the configuration in the bottom section of FIG. 12, at step S400, by employing the generating function 110e, the processing circuitry 110 divides the data resulting from performing the fast Fourier transform 61 on the corrected data output at step S300, by the data resulting from a fast Fourier transform 64 performed on the complementary data output at step S200, further performs the partial sampling process 62 on the quotient, subsequently carries out the multiplication 63 by the scalar value N, and multiplies the result by the partial sampling data 50, so as to use the generated value as second partial sampling data serving as new partial sampling data.

### Fifth Embodiment

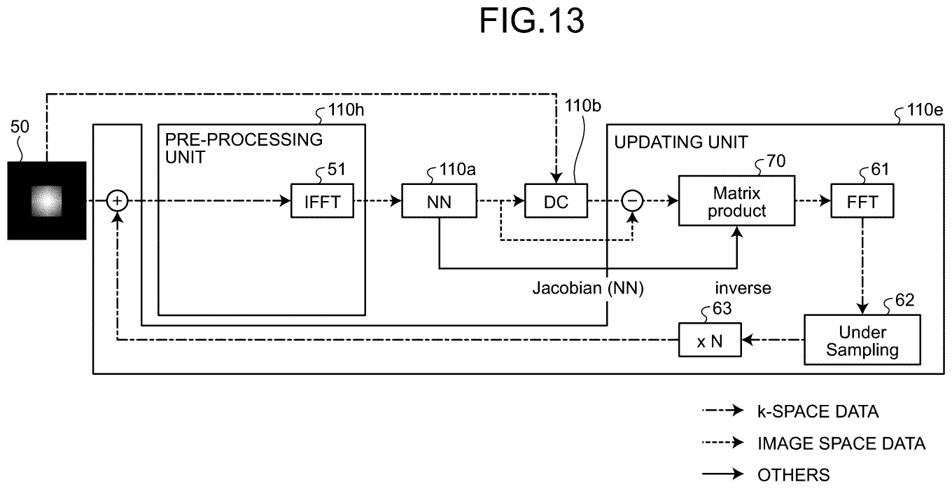

In a fifth embodiment, an example will be explained in which, by employing the generating function 110e, the processing circuitry 110 is configured to generate second partial sampling data by using a process including a matrix product calculation. FIG. 13 illustrates an example with the above configuration. In the example in FIG. 13, processes performed by the pre-processing unit and the generating unit are different from those in the example in the top section of FIG. 12.

In the fifth embodiment, by employing the pre-processing function 110h, the processing circuitry 110 is configured to carry out the inverse fast Fourier transform 51 on the partial sampling data 50 and to input the data to a neural network serving as the complementing function 110a. Unlike the example in the top section of FIG. 12, the low-pass filter (LPF) 52 is not used.

At step S400, by employing the generating function 110e, the processing circuitry 110 generates second partial sampling data by using a process including a matrix product calculation 70. In this situation, it is possible to express an output vector Iᵢ^{out} of a neural network NN realized by the complementing function 110a, by using Expression (1) presented below where Iⱼⁱⁿ denotes an input vector.

$${I}_{i}^{out} = NN ( {I}_{j}^{in} ) \qquad ( 1 )$$

It is possible to express a Jacobian value of the neural network NN by using Expression (2) presented below.

$$Jacobian ( NN ) = \frac{\partial {I}_{i}^{out}}{\partial {I}_{j}^{in}} \qquad ( 2 )$$

Furthermore, it is possible to express an output vector Iᵢ^{update} resulting from the process with the matrix product calculation 70, by using Expression (3) presented below,

$${I}_{i}^{update} = {\sum }_{j} {( \frac{\partial {I}_{i}^{out}}{\partial {I}_{j}^{in}} )}^{- 1} {( {I}^{{DC}_{out} - {DC}_{in}} )}_{j} \qquad ( 3 )$$

In Expression (3), I^{DC_out} denotes an output after the DC process performed by the correcting function 110b, whereas I^{DC_in} denotes an input before the DC process performed by the correcting function 110b.

In other words, by employing the generating function 110e, the processing circuitry 110 is configured to output, as a processing result of the matrix product calculation 70, a matrix product of: the difference between the corrected data being the output after the DC process performed by the correcting function 110b and the complementary data being the input before the DC process; and an inverse matrix of the Jacobian value of the neural network related to the complementing function 110a. By employing the generating function 110e, the processing circuitry 110 is configured to carry out the fast Fourier transform 61 on the processing result of the matrix product calculation 70, to subsequently perform the partial sampling process 62, to carry out the multiplication 63 by the scalar value N, and to add the result to the partial sampling data 50, so as to use the generated value as second partial sampling data serving as new partial sampling data.

According to at least one aspect of the embodiments described above, it is possible to enhance the learning efficiency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising processing circuitry configured:
to output first complementary data by inputting, to a first neural network, first partial sampling data resulting from performing a partial sampling process;
to obtain first corrected data, by performing a process to improve a consistency degree between the first complementary data and the first partial sampling data;
to generate second partial sampling data, on a basis of the first corrected data and the first partial sampling data; and
to output second complementary data, by inputting the second partial sampling data to a second neural network.

2. The data processing apparatus according to claim 1, wherein the processing circuitry is configured to generate an image by performing a reconstructing process on a basis of the second complementary data.

3. The data processing apparatus according to claim 1, wherein the second neural network is a same neural network as the first neural network.

4. The data processing apparatus according to claim 1, wherein the second partial sampling data is data obtained by sampling data points in same positions as those used for the first partial sampling data.

5. The data processing apparatus according to claim 1, wherein the processing circuitry is configured to generate one of the first partial sampling data and the second partial sampling data, by performing a pre-processing process on data resulting from a partial sampling process.

6. The data processing apparatus according to claim 1, wherein the processing circuitry is configured to generate the second partial sampling data, on a basis of a difference between the first corrected data and the first complementary data.

7. The data processing apparatus according to claim 6, wherein the processing circuitry is configured to generate the second partial sampling data, by adding an output of a mathematical function that uses the difference as an input, to the first partial sampling data.

8. The data processing apparatus according to claim 1, wherein the processing circuitry is configured to generate the second partial sampling data, on a basis of a ratio between the first corrected data and the first complementary data.

9. The data processing apparatus according to claim 8, wherein the processing circuitry is configured to generate the second partial sampling data, by multiplying the first partial sampling data by a mathematical function that uses the ratio as an input.

10. The data processing apparatus according to claim 1, wherein the processing circuitry is configured to generate the second partial sampling data, while including a process of carrying out a partial sampling process.

11. The data processing apparatus according to claim 10, wherein a sampling percentage of a partial sampling process performed at a time of generating the second partial sampling data is different from a sampling percentage of a partial sampling process performed at a time of generating the first partial sampling data.

12. The data processing apparatus according to claim 10, wherein the processing circuitry is configured to ensure that sampling positions of the partial sampling process performed at the time of generating the second partial sampling data are different from sampling positions of the partial sampling process performed at the time of generating the first partial sampling data.

13. The data processing apparatus according to claim 1, wherein the processing circuitry is configured to generate the second partial sampling data, by using a process including a matrix product calculation.

14. The data processing apparatus according to claim 1, wherein the processing circuitry is configured to generate the second partial sampling data, by using a gradient of the first neural network.

15. A magnetic resonance imaging apparatus comprising:
sequence controlling circuitry configured to acquire the first partial sampling data by executing a pulse sequence; and
the data processing apparatus according to claim 1.

16. A data processing method comprising:
outputting first complementary data by inputting, to a first neural network, first partial sampling data resulting from performing a partial sampling process;
obtaining first corrected data, by performing a process to improve a consistency degree between the first complementary data and the first partial sampling data;
generating second partial sampling data, on a basis of the first corrected data and the first partial sampling data; and
outputting second complementary data, by inputting the second partial sampling data to a second neural network.
